(19) United States
(12) Patent Application Publication
(10) Pub. No.: US 2009/0016166 A1
(43) Pub. Date: Jan. 15, 2009

(54) TEXT MESSAGE ACTIVATED ALARM CLOCK

(75) Inventor: Tamer E. Abuelsaad, Poughkeepsie, NY (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/774,658

(22) Filed: Jul. 9, 2007

(51) Int. Cl. G04F 8/00; G04F 10/00

(52) U.S. Cl. 368/9

(57) ABSTRACT

A method for adjusting an alarm activation time of an alarm clock includes: selecting a revised alarm activation time; broadcasting the revised alarm activation time to the alarm clock as a text message; and confirming the revised alarm activation time. A computer program product and alarm clock are disclosed.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to schedule management and particularly to techniques for remote management of alarms on a personal alarm clock.

2. Description of the Related Art

In the busy world that we have today, every one is inundated with appointments and schedule changes. In the midst of all this, the time at which one wakes up may change to adapt to the schedule of the next day. For example, one may make plans to drop off their car early in the morning for repair during the day. Unfortunately, such plans may be made while the individual is away from home, such as at work. Frequently, individuals may make such plans and forget to adjust the wake up time on their alarm clock when they return home.

What are needed are techniques for remote management of an alarm time on a personal alarm clock. Preferably such techniques are amenable to use by a multiplicity of platforms, thus providing for a high degree of access.

### SUMMARY OF THE INVENTION

The shortcomings of the prior art are overcome and additional advantages are provided through the provision of a method for adjusting an alarm activation time of an alarm clock includes: selecting a revised alarm activation time; broadcasting the revised alarm activation time to the alarm clock as a text message; and confirming the revised alarm activation time.

Also disclosed is an alarm clock adapted for remote management of an alarm activation time, the alarm clock including: an input for receiving the alarm activation time from a remote source; a computer program product including machine readable instructions stored on machine readable media within the alarm clock, the product including instructions for adjusting the alarm activation time according to the input alarm activation time.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a user is provided with an ability to remotely manage alarm activation times of an alarm clock. As an example, technically we have achieved a solution where a computer program product comprising machine executable instructions stored on machine readable media, is provided. The computer program product includes instructions for remote management of an alarm activation time of an alarm clock, the product including instructions for: receiving an input of the alarm activation time; generating an instruction set for the alarm clock, the instruction set including instructions for adjusting an alarm activation time; communicating the instruction set to the alarm clock; and setting the alarm activation time in the alarm clock.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a communications infrastructure;

The detailed description explains the preferred embodiments of the invention, together with advantages and features, by way of example with reference to the drawings.

### DETAILED DESCRIPTION OF THE INVENTION

The teachings herein provide for remote management of an alarm on a personal alarm clock. The remote management permits a user to at least one of set and adjust at least one alarm activation time of the clock. Accordingly, the user is provided with an ability to “set it and forget it.”

The teachings herein generally take advantage of apparatus as are known in the art. For example, messaging network apparatus may be used to provide a text message to the clock. However, the recipient clock includes apparatus for receipt and application of text messages, or other types of similar messages or instruction sets. Other aspects will become apparent when considering this disclosure as a whole.

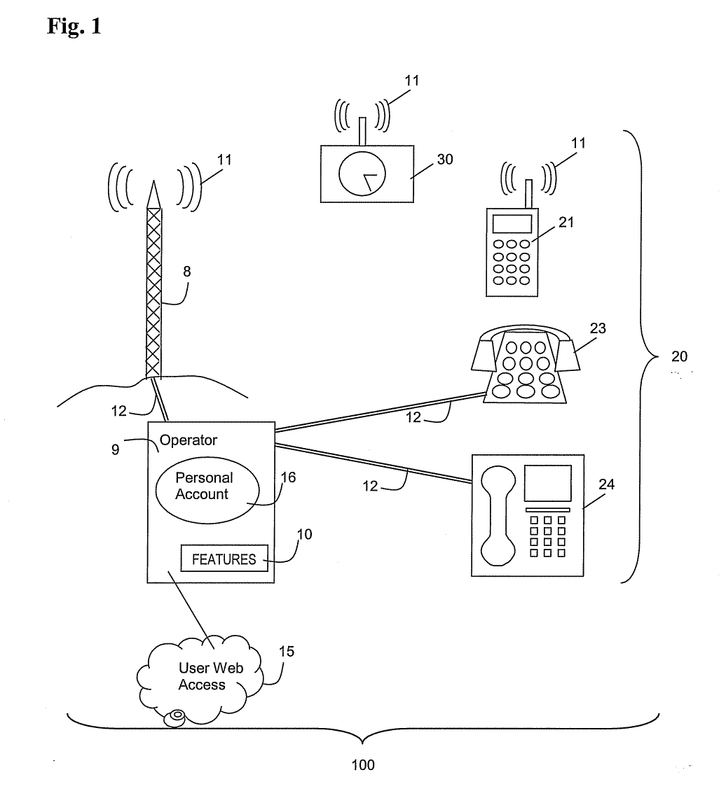

Referring now to FIG. 1, aspects of an exemplary communications infrastructure 100 are shown. The communications infrastructure 100 depicted herein includes a plurality of communications devices 20. Exemplary communications devices 20 include mobile stations 21, such as at least one of a cellular telephone and a satellite telephone. Typically, the mobiles stations 21 communicate with the communications infrastructure 100 by use of a radio signal 11 produced by a radio tower 8. Other communications devices 20 include fixed stations such as and without limitation, a home telephone 23 and a business telephone 24. Typically, the fixed stations communicate with the communications infrastructure 100 by use of communications lines 12.

In typical embodiments, the communications infrastructure 100 is managed by an operator 9. As used herein, the operator 9 includes all resources necessary for operating and maintaining the communications infrastructure 100. Exemplary components, generally not depicted herein (for purposes of simplicity), include, without limitation: computers and components thereof, power supplies, personnel, communications networks, etc. As examples of components of the operator 9, the communications lines 12 as well as the radio signal 11 are used to connect a base station (not shown) of the operator 9 with the various communications devices 20.

In some embodiments, users are provided access to and control over a personal account 16 maintained by the operator 9. Exemplary types of access include user web access 15 available through the Internet.

In typical embodiments, the operator 9 maintains voice mail for each user. In these embodiments, a voice mail account is associated with each personal account 16. Access to voice mail may be had through remote systems, such as through the user web access 15 or through one of the communications devices 20.

The communications infrastructure may include any one or more of a cellular network, a fixed network, a private network (such as a corporate network), or any other type of communications infrastructure 100.

An alarm management feature 10 for the communications infrastructure 100, as disclosed herein, may be implemented through various techniques. For example, the alarm management feature 10 may be implemented as software including machine readable instructions stored as a computer program product. The computer program product, or software, may be stored using any one or more of a variety of media. Non-limiting examples of media include, magnetic media, optical media, magneto-optical media, read-only memory (ROM), random-access memory (RAM), a flash memory, a hard drive, a tape drive and others. Typically, the storage is a part of the operator 9. However, in some embodiments, the storage may be included, at least in part within the communications devices 20. In one embodiment, at least a portion of the alarm management feature 10 is manually implemented by call center personnel.

In some embodiments, included in the communications infrastructure 100 is an alarm clock 30. That is, the alarm clock 30 may be adapted for receipt of instructions from the communications infrastructure 100. Instructions may be sent to the alarm clock using a variety of protocols. One non-limiting example includes use of short-messaging-service (SMS) protocol (e.g., a text message). Other protocols, including proprietary protocols, may be used. Instructions may be sent through a variety of techniques. Exemplary techniques include, without limitation, use of wireless (a radio signal 11), use of a communication line 12 (such as a telephone line), and by modulation of a power supply (such as the AC current powering the clock 30).

The clock 30 may include apparatus as needed for implementation of the teachings herein. For example, and without limitation, the clock 30 may include an address, at least one set of machine readable instructions stored on machine readable media (i.e., software), a receiver or transceiver, memory, a processor, a display, a network interface, a user interface and other such devices. The software of the clock 30 may include a built in calendar (including, for example, multiple alarm set times), message receipt instructions, interface management and other such functionality.

The alarm management feature 10 may reside at least in the clock 30, the communications network 100, and in any combination deemed suitable. In general, the user is provided with an ability to easily access alarm features of the clock 30. For example, when using a web access 15, the user may be provided with all settings for the clock 30. That is, the user may be provided with an ability to review and selectively adjust alarm settings over some extended period of time. In some embodiments, the alarm clock 30 receives an alarming instruction, and provides an existing set time to the user. The user is then provided with an ability to review and override the existing set time. In other embodiments, the alarm management feature 10 may provide for simple pass-through of instructions. For example, the feature 10 may simply pass instructions from the user to the clock 30. In this embodiment, it may be considered that the clock 30 is set up as a “dumb terminal” which is enabled to receive only. One skilled in the art will recognize that a variety of techniques for communication to or with the clock 30 may be had. Accordingly, these examples are merely illustrative and are non-limiting of the teachings herein.

The clock 30 may be accessed according to a unique address. For example, the clock 30 may have a unique internet-protocol (IP) address. The clock 30 may have a sub-address and is only accessible through a network, such as a home network. In this embodiment, the user may be afforded the security of the home network.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for adjusting an alarm activation time of an alarm clock, the method comprising:
selecting a revised alarm activation time;
broadcasting the revised alarm activation time to the alarm clock as a text message; and
confirming the revised alarm activation time.

2. The method as in claim 1, wherein selecting comprises using at least one of a web access, a business telephone, a home telephone and a mobile station.

3. The method as in claim 1, wherein broadcasting comprises using at least one of a communication line, a radio signal and modulating a power supply.

4. A computer program product comprising machine executable instructions stored on machine readable media, the instructions for remote management of an alarm activation time of an alarm clock, the product comprising instructions for:
receiving an input of the alarm activation time;
generating an instruction set for the alarm clock, the instruction set comprising instructions for adjusting an alarm activation time;
communicating the instruction set to the alarm clock; and
setting the alarm activation time in the alarm clock.

5. The computer program product as in claim 4, further comprising instructions for receiving a plurality of inputs.

6. An alarm clock adapted for remote management of an alarm activation time, the alarm clock comprising:
an input for receiving the alarm activation time from a remote source;
a computer program product comprising machine readable instructions stored on machine readable media within the alarm clock, the product comprising instructions for adjusting the alarm activation time according to the input alarm activation time.
